(19) United States
(12) Patent Application Publication
(10) Pub. No.: US 2025/0026334 A1
(43) Pub. Date: Jan. 23, 2025

(54) APPARATUS FOR CONTROLLING A POWER SOURCE OF A HYBRID VEHICLE, AN OPERATING METHOD THEREOF, AND A SYSTEM HAVING THE SAME

(71) Applicants: HYUNDAI MOTOR COMPANY, Seoul (KR); KIA CORPORATION, Seoul (KR)

(72) Inventor: Key Chun Park, Yongin-si (KR)

(73) Assignees: HYUNDAI MOTOR COMPANY, Seoul (KR); KIA CORPORATION, Seoul (KR)

(21) Appl. No.: 18/388,400

(22) Filed: Nov. 9, 2023

(30) Foreign Application Priority Data
Jul. 19, 2023 (KR) 10-2023-0094112

(51) Int. Cl. B60W 20/15; B60W 10/06

(52) U.S. Cl. CPC B60W 20/15; B60W 10/06; B60W 2510/0657; B60W 2710/0666

(57) ABSTRACT

An apparatus for controlling a power source of a hybrid vehicle, an operating method thereof, and a system including the same predict engine torque fluctuations in real time based on an engine RPM and a required engine torque. The apparatus includes a storage configured to store one or more algorithms for predicting engine torque fluctuations and one or more look-up tables (LUT). The apparatus has a power source controller configured to predict an inertial torque and a pressure torque related to an engine based on engine-related information and predict engine torque fluctuations based on the engine-related information, the inertial torque, and the pressure torque. The power source controller is further configured to output a reverse torque instruction to offset the engine torque fluctuations.

### CROSS REFERENCE TO RELATED APPLICATION

The present application claims the benefit of and priority to Korean Patent Application No. 10-2023-0094112, filed on Jul. 19, 2023, the entire contents of which are incorporated herein by reference.

### TECHNICAL FIELD

The present disclosure relates generally to an apparatus for controlling a power source of a hybrid vehicle, and more particularly to an apparatus for controlling a power source of a hybrid vehicle, an operating method thereof, and a system including the same.

### BACKGROUND

A powertrain of a hybrid vehicle typically includes an internal combustion engine and a motor connected to a rotating shaft of the internal combustion engine. In connection with the powertrain of the hybrid vehicle, there are technologies of using the motor to control the reverse phase of an engine torque.

To control the reverse phase of the engine torque, it is important to predict the torque fluctuations of the engine. However, in the related art, the prediction of the engine torque fluctuations is not implemented in an upper-level controller such as a hybrid control unit.

Generally, engine control variables (e.g., valve timing, intake pressure, spark timing, air-fuel ratio, fuel quantity, etc.) are taken into account at various operating points of the engine in order to predict the engine torque fluctuations. However, it may not be suitable for the upper-level controller to compute such engine control variables in real time because the variables are not obtainable in the upper-level controller. Further, a large amount of computation is required to predict the engine torque fluctuations.

The statements in this section merely provide background information related to the present disclosure and may not constitute prior art.

### SUMMARY

Embodiments of the present disclosure have been devised according to the aforementioned needs. A technical aspect of the present disclosure is to provide a technology of predicting engine torque fluctuations. The technology can be applied to an upper-level controller of a hybrid vehicle, such as a hybrid control unit of the hybrid vehicle.

Further, embodiments of the present disclosure address a technical aspect of providing an apparatus for controlling a power source of a hybrid vehicle, an operating method thereof, and a system including the same, in which torque fluctuations of an engine are predicted based on an engine revolutions per minute (RPM) and a required engine torque.

Further, embodiments of the present disclosure address a technical aspect of providing an apparatus for controlling a power source of a hybrid vehicle, an operating method thereof, and a system including the same, in which torque fluctuations of an engine are predicted, and reverse phase control for an engine torque is performed based on the predicted torque fluctuations of the engine.

The technical aspects of the present disclosure are not limited to those mentioned above. Rather, other aspects intended by the present disclosure should be more clearly understood from the following description by a person having ordinary skill in the art to which the present disclosure pertains.

The foregoing technical aspects may be achieved by providing a method of predicting torque fluctuations of an engine. The method may be performed by an upper-level controller of a hybrid vehicle, such as a hybrid control unit of the hybrid vehicle.

According embodiments, an apparatus for controlling a power source of a hybrid vehicle, an operating method thereof, and a system including the same may be provided, in which torque fluctuations of an engine are predicted based on an engine revolutions per minute (RPM) and a required engine torque.

According to embodiments, an apparatus for controlling a power source of a hybrid vehicle, an operating method thereof, and a system including the same may be provided, in which torque fluctuations of an engine are predicted, and a reverse phase control for an engine torque is performed based on the predicted engine torque fluctuations.

According to an embodiment, an apparatus for controlling a power source of a hybrid vehicle is provided. The apparatus may include a storage configured to store one or more algorithms for predicting engine torque fluctuations and one or more look-up tables (LUT), The apparatus may also include a power source controller. The power source controller may be configured to predict an inertial torque and a pressure torque related to an engine based on engine-related information. The power source controller may also be configured to predict engine torque fluctuations based on the engine-related information, the inertial torque, and the pressure torque. The power source controller may additionally be configured to output a reverse torque instruction to offset the engine torque fluctuations.

According to an embodiment, the power source controller may be configured to predict a reverse torque to offset the engine torque fluctuations. The power source controller may be configured to output the reverse torque instruction corresponding to the reverse torque.

According to an embodiment, the power source controller may be configured to predict the engine torque fluctuations by subtracting a required engine torque from a sum of the inertial torque and the pressure torque.

According to an embodiment, the engine-related information may include engine RPM and a required engine torque.

According to an embodiment, the power source controller may be configured to predict the inertial torque corresponding to the engine RPM with reference to an inertial torque LUT tabulated with the inertial torque according to the engine RPM.

According to an embodiment, the power source controller may be configured to predict a motoring pressure torque based on the engine RPM and the required engine torque, with respect to the pressure torque. The power source controller may be configured to predict the combustion pressure torque based on the required engine torque.

According to an embodiment, the power source controller may be configured to predict the motoring pressure torque with reference to the motoring pressure torque LUT tabulated with the motoring pressure torque according to the engine RPM and the required engine torque.

According to an embodiment, the power source controller may be configured to extract a first motoring pressure torque from an idle state motoring pressure torque LUT. The power source controller may be further configured to extract a second motoring pressure torque from an open state motoring pressure torque LUT. The power source controller may also be configured to predict the motoring pressure torque based on a sum of the first motoring pressure torque and the second motoring pressure torque.

According to an embodiment, a method of operating an apparatus for controlling a power source of a hybrid vehicle is provided. The method may include predicting an inertial torque based on engine-related information and predicting a pressure torque based on the engine-related information. The method may additionally include predicting engine torque fluctuations based on the engine-related information, the inertial torque, and the pressure torque. The method may further include outputting a reverse torque instruction to offset the engine torque fluctuations.

According to an embodiment, predicting the engine torque fluctuations may include predicting the engine torque fluctuations by subtracting a required engine torque from a sum of the inertial torque and the pressure torque.

According to an embodiment, the engine-related information may include an engine RPM and a required engine torque.

According to an embodiment, predicting the inertial torque may include predicting the inertial torque corresponding to the engine RPM with reference to the inertial torque LUT tabulated with the inertial torque according to the engine RPM.

According to an embodiment, predicting the pressure torque may include predicting a motoring pressure torque based on the engine RPM and the required engine torque and may include predicting a combustion pressure torque based on the required engine torque.

According to an embodiment, predicting the pressure torque may include predicting the motoring pressure torque with reference to the motoring pressure torque LUT tabulated with the motoring pressure torque according to the engine RPM and the required engine torque.

According to an embodiment, predicting the pressure torque may include extracting a first motoring pressure torque from an idle state motoring pressure torque LUT and extracting a second motoring pressure torque from an open state motoring pressure torque LUT. The method may also include predicting the motoring pressure torque based on a sum of the first motoring pressure torque and the second motoring pressure torque.

According to an embodiment, outputting the reverse torque instruction may include predicting the reverse torque to offset the engine torque fluctuations and outputting the reverse torque instruction corresponding to the reverse torque.

According to an embodiment, system for controlling a power source of a hybrid vehicle is provided. The system may include a vehicle information provider configured to provide vehicle-related information. The system may also include an apparatus for controlling the power source of the hybrid vehicle according to the embodiments of the present disclosure. The system may additionally include a motor control unit (MCU) configured to control a motor based on a reverse torque instruction output from the apparatus for controlling the power source of the hybrid vehicle.

Details based on various examples of the present disclosure, including examples other than provided in the foregoing summary, are provided in the following description and the accompanying drawings.

According to an embodiment of the present disclosure, there may be provided a method of predicting torque fluctuations of an engine based on an engine revolutions per minute (RPM) and a required engine torque.

The method of predicting the engine torque fluctuations, according to embodiments of the present disclosure, may be applied to an upper-level controller of a hybrid vehicle, e.g., a hybrid control unit, because internal combustion engine control variables (e.g., valve timing, spark timing, air volume, throttle valve angles, etc.) are not used.

Further, the method of predicting the engine torque fluctuations, according to embodiments of the present disclosure, does not require much information to predict the torque fluctuations of the engine, thereby requiring not much computation to predict the engine torque fluctuations, and predicting the engine torque fluctuations in real time and efficiently.

In a system where the hybrid control unit and the engine control unit are separated, high-speed communication is required for fast information exchange between the two controllers, but resources for the high-speed communication are limited. Under such a system environment, the method of predicting the engine torque fluctuations according to embodiments of the present disclosure may be effectively applied to the hybrid control unit.

The effects of the disclosure are not limited to those mentioned above. Other effects not mentioned above should become apparent to those having ordinary skill in the art from the following description.

The foregoing problems to be solved, means for solving the problems, and the effects do not specify the essential features of the appended claims. The scope of the appended claims is not limited to the following description.

### BRIEF DESCRIPTION OF THE DRAWINGS

The accompanying drawings are intended to enhance understanding of the embodiments of the present disclosure. However, the technical features of the embodiments are not limited to the specific drawings. For example, the features disclosed in the drawings may be combined to implement new embodiments.

FIG. 1 is a diagram showing a configuration of a power source control system in a hybrid vehicle, according to an embodiment of the present disclosure.

FIG. 2 is a diagram showing a configuration based on a first example of a powertrain system, according to an embodiment of the present disclosure.

FIG. 3 is a diagram showing a configuration based on a second example of a powertrain system, according to an embodiment of the present disclosure.

FIG. 4 is a diagram showing a configuration based on a third example of a powertrain system, according to an embodiment of the present disclosure.

FIG. 5 is a diagram showing a configuration of an upper-level controller (or an apparatus for controlling a power source of a hybrid vehicle), according to an embodiment of the present disclosure.

FIG. 6 is a diagram showing a configuration of a power source controller, according to an embodiment of the present disclosure.

FIG. 7 is a diagram for describing operations of an upper-level controller (or an apparatus for controlling a power source of a hybrid vehicle), according to an embodiment of the present disclosure.

### DETAILED DESCRIPTION

Advantages and features of the present disclosure and

methods of accomplishing the same should be understood more readily by reference to the detailed description of embodiments that are provided hereinafter with reference to the accompanying drawings. The present disclosure may, however, be embodied in many different forms and should not be construed as being limited to the embodiments set forth herein. Rather, the embodiments are provided so that the disclosure is thorough and complete and fully conveys the concepts of the disclosure to those having ordinary skill in the art. The disclosure should only be defined by the appended claims.

The shapes, sizes, proportions, angles, numbers, etc. illustrated in the accompanying drawings to describe the embodiments of the present disclosure are merely illustrative. The present disclosure is not limited to the illustrated embodiments. Throughout the specification, the same reference numerals refer to the same elements. In the following description, when the detailed description of the relevant known art has been determined to unnecessarily obscure the disclosure, the detailed description may have been omitted. Where terms “comprise,” “have,” and “include” described in the present specification are used, another part may be added unless a more limiting term, such as “only,” is used. The terms of a singular form may include plural forms unless the otherwise clearly specified in context.

In construing an element, the element should be construed as including an error or tolerance range even where no explicit description of such an error or tolerance range is provided.

In the following description, a time relationship, for example, when the temporal order is described as “after”, “subsequent”, “next”, and “before”, a case that the temporal order is not continuous may be included unless “just” or “direct” is used.

Although the terms “first”, “second”, and the like are used to describe various elements, these elements are not limited by these terms. These terms are merely used for distinguishing one element from other elements. Therefore, for example, the first element mentioned hereinafter may be the second element in the technical sense of the present disclosure.

It should also be understood that, while terms such as “first,” “second,” “A,” “B,” “(a),” and “(b)” may be used herein to describe various elements, such terms are only used to distinguish one element from another element. The substance, sequence, order, or number of these elements is not limited by these terms.

It should be understood that, when an element is referred to as being “connected to” or “coupled to” another element, not only can it be “directly connected or coupled to” the other element, but it can also be “indirectly connected or coupled to” the other element via an “intervening” element. In the same context, it should be understood that, when an element is referred to as being formed “on” or “under” another element, not only can it be directly formed on or under another element, but it can also be indirectly formed on or under another element via an intervening element.

When a component, device, element, or the like of the present disclosure is described as having a purpose or performing an operation, function, or the like, the component, device, or element should be considered herein as being “configured to” meet that purpose or perform that operation or function.

Terms such as “˜unit”, “˜part,” “˜block,” “˜member,” “˜module,” and the like may denote a unit for performing at least one function or operation. For example, the terms may refer to at least one hardware component such as a field-programmable gate array (FPGA) or an application specific integrated circuit (ASIC), at least one software stored in a memory, or at least one process performed by a processor.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as the first item, the second item, or the third item.

In various embodiments of the present disclosure, features may be partially or entirely coupled or combined and may be interlocked and operated in various technical ways. Further, the embodiments may be implemented independently of each other or in conjunction with each other.

With reference to the accompanying drawings and the following embodiments, the embodiments of the present disclosure are as follows. Because a scale of each element shown in the accompanying drawings may be different from an actual scale for convenience of description, the present disclosure is not limited to the shown scale.

Below, an apparatus for controlling a power source of a hybrid vehicle, an operating method thereof, and a system including the same, according to embodiments, are described with reference to the accompanying drawings.

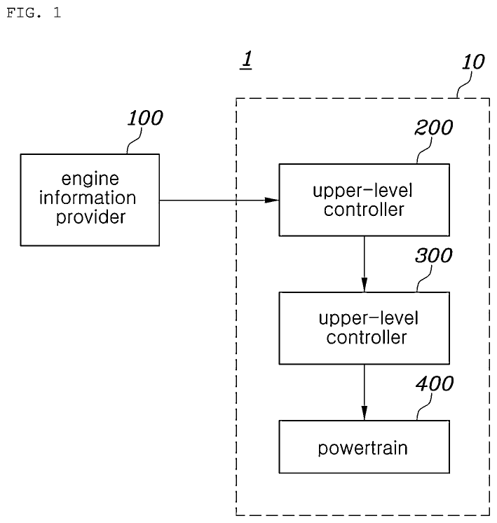

FIG. 1 is a diagram showing a configuration of a system 1 for controlling a power source in a hybrid vehicle, according to an embodiment of the present disclosure.

The system 1 (sometimes referred to herein as a HV power source control system or a power source control system) may include an upper-level controller (e.g., a hybrid control unit) that is capable of predicting torque fluctuations (e.g., roll vibration torque components) of an engine.

The power source control system 1 may be configured to predict engine torque fluctuations in real time based on a small number of variables (e.g., an engine revolutions per minute (RPM) and a required engine torque).

Further, the power source control system 1 may be configured to predict an inertial torque and a pressure torque. The power source control system 1 may efficiently predict the torque fluctuations of the engine based on the predicted inertial torque and pressure torque and the required engine torque.

Further, the power source control system 1 may be configured to predict a motoring pressure torque and a combustion pressure torque classified from the pressure torque.

Referring to FIG. 1, the power source control system 1 may include, but not limited to, an engine information provider 100, an upper-level controller 200, a lower-level controller 300, and a powertrain 400.

According to an embodiment, the upper-level controller 200, the lower-level controller 300, and the powertrain 400 may make up a powertrain system 10 for a hybrid vehicle.

The engine information provider 100 may provide engine-related information to the upper-level controller 200. The engine information may be used in predicting the engine torque fluctuations by the upper-level controller 200.

The engine-related information that may be provided by the engine information provider 100 may include the engine RPM (or engine speed) and the required engine torque.

In an embodiment, the engine information provider 100 may be an engine control unit (ECU).

The upper-level controller 200 (or the HV power source control device) may predict the engine torque fluctuations based on the engine-related information (e.g., the engine RPM, and the required engine torque) received from the engine information provider 100. The engine torque fluctuations may refer to an engine roll vibration torque (or an engine roll vibration torque component), for example.

According to an embodiment, the upper-level controller 200 may be a hybrid control unit (HCU).

The upper-level controller 200 may predict the inertial torque (or an inertial torque component) based on the engine RPM of the engine-related information.

The inertial torque may refer to a torque generated in a crankshaft by means of a connecting rod while a reciprocating mass (e.g., a piston pack, and the big end of the effective connecting rod) reciprocates as the engine operates. The inertial torque may be proportional to the square of the engine RPM.

To predict the inertial torque, the upper-level controller 200 may store a preset inertial torque look-up table (LUT) determined based on an engine dynamometer test of analyzing the inertial torque according to the engine RPM.

The upper-level controller 200 may predict the pressure torque (or the pressure torque component) based on the engine RPM and the required engine torque of the engine-related information. According to an embodiment, the upper-level controller 200 may predict the motoring pressure torque and the combustion pressure torque as the pressure torque.

The motoring pressure torque may refer to a crank torque generated by the inflow and outflow of air without the combustion of the engine.

To predict the motoring pressure torque, the upper-level controller 200 may store a preset motoring pressure torque LUT determined based on the engine dynamometer test of analyzing the motoring pressure torque according to the engine RPM and the required engine torque.

According to an embodiment, the upper-level controller 200 may estimate the motoring pressure torque based on the motoring pressure torque of when a throttle valve is closed and the motoring pressure torque of when the throttle valve is fully open.

The closed state of the throttle valve may be represented as an idle state or a minimum throttle opening state. The fully open state of the throttle valve may be represented as an open state (or entirely open state) or the maximum throttle opening state.

For example, the upper-level controller 200 may refer to the motoring pressure torque LUT set with the additional motoring pressure torque analyzed according to the engine RPM and the required engine torque when the throttle valve is closed. The upper-level controller 200 may also refer to the additional motoring pressure torque analyzed according to the engine RPM and the required engine torque when the throttle valve is fully open.

Alternatively, the upper-level controller 200 may store a preset idle state motoring pressure torque LUT determined based on analysis according to the engine RPM and the required engine torque when the throttle valve is closed. The upper-level controller 200 may store a preset open state motoring pressure torque LUT determined based on analysis according to the engine RPM and the required engine torque when the throttle valve is fully open.

The upper-level controller 200 may extract the motoring pressure torque corresponding to the engine RPM and the required engine torque from each of the idle state motoring pressure torque LUT and the open state motoring pressure torque LUT. The upper-level controller 200 may then predict the motoring pressure torque by adding the two extracted motoring pressure torques.

The motoring pressure torque extracted from the idle state motoring pressure torque LUT is sometimes referred to herein as a first motoring pressure torque. The motoring pressure torque extracted from the open state motoring pressure torque LUT is sometimes referred to herein as a second motoring pressure torque.

The combustion pressure torque may refer to a torque based on a pressure component due to pure combustion excluding the motoring pressure from the pressure generated when combustion occurs in the engine. While the inertial torque and the motoring pressure torque have a mean torque of ‘0’, the combustion pressure torque may have a mean torque component in addition to a torque fluctuation component.

According to an embodiment, to predict the combustion pressure torque, the upper-level controller 200 may store a preset combustion pressure torque LUT determined based on an engine dynamometer test of analyzing the combustion pressure torque according to the required engine torque.

The upper-level controller 200 may predict the engine torque fluctuations based on the inertial torque, the pressure torque (the motoring pressure torque and the combustion pressure torque), and the required engine torque.

According to an embodiment, the upper-level controller 200 may predict the engine torque fluctuations through a process of subtracting the required engine torque from the sum of the inertial torque and the pressure torque.

The upper-level controller 200 may predict reverse torque for the engine torque fluctuations to offset the predicted engine torque fluctuations. The reverse torque may have an opposite phase to, and the same magnitude as, the engine torque fluctuations.

The upper-level controller 200 may output a reverse torque instruction (sometimes referred to herein as a reverse torque command) corresponding to the reverse torque to the lower-level controller, e.g., a motor control unit (MCU). Thus, the MCU may control a motor of the powertrain based on the reverse torque instruction received from the upper-level controller 200, thereby performing reverse torque vibration control.

The lower-level controller 300 may control the powertrain 400 based on an engine control torque instruction and a motor control torque instruction (including the reverse torque instruction) received from the upper-level controller 200.

According to an embodiment, the MCU of the lower-level controller 300 may control the motor based on the motor control torque instruction output from the upper-level controller 200, thereby performing the reverse torque vibration control.

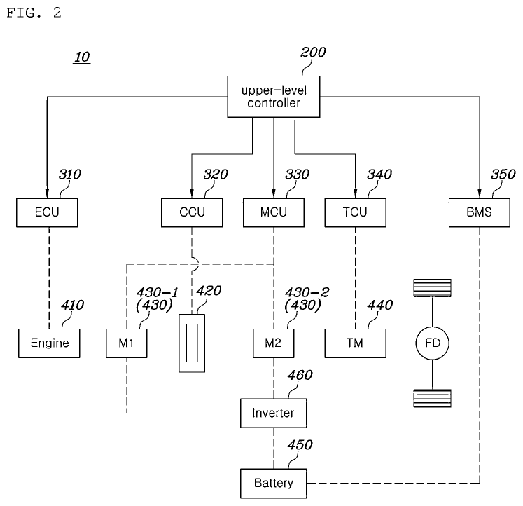

FIG. 2 is a diagram showing a configuration based on a first example of a powertrain system, according to an embodiment of the present disclosure.

Referring to FIGS. 1 and 2, the lower-level controller 300 may include an engine control unit (ECU) 310, a clutch control unit (CCU) 320, an MCU 330, a transmission control unit (TCU) 340, and a battery management system (BMS) 350.

Further, the powertrain 400 may include an engine 410, a clutch 420, at least one motor 430, a transmission (TM) 440, a battery 450, and an inverter 460. According to an embodiment, the powertrain 400 may include a first motor (M1) 430-1 and a second motor (M2) 430-2.

The ECU 310 may control the engine 310 in response to the control of the upper-level controller 200. The CCU 320 may control the clutch 420 in response to the control of the upper-level controller 200.

The MCU 330 may control the motor 430 in response to the control of the upper-level controller 200. The TCU 340 may control the TM 440 in response to the control of the upper-level controller 200.

The BMS 350 may control the battery 450 in response to the control of the upper-level controller 200. The inverter 460 may supply power from the battery 450 to the motor 430.

According to an embodiment, the clutch 420 may be connected between the engine 410 and the TM 440, the first motor 430-1 may be connected between the engine 410 and the clutch 420, and the second motor 430-2 may be connected between the clutch 420 and the TM 440.

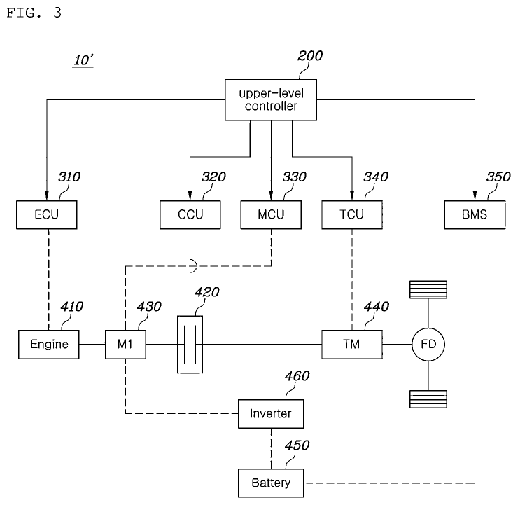

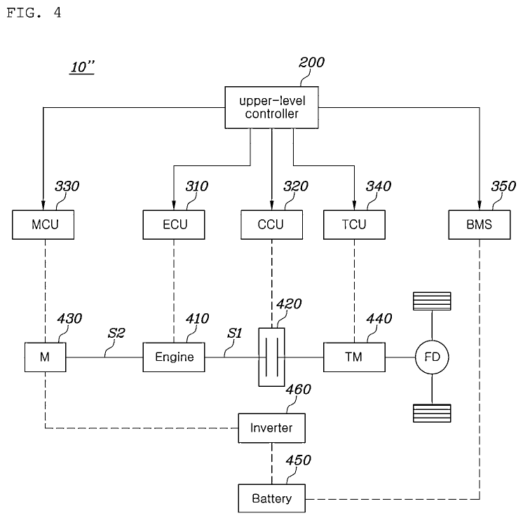

FIG. 3 is a diagram showing a configuration based on a second example of a powertrain system, according to an embodiment of the present disclosure. FIG. 4 is a diagram showing a configuration based on a third example of a powertrain system, according to an embodiment of the present disclosure.

A powertrain system 10′ according to the second example and a powertrain system 10″ according to the third example are different from the powertrain system 10 according to the first example in that, whereas the powertrain system 10 according to the first example includes multiple motors 430, the powertrain system 10′ and powertrain system 10″ each includes a single motor 430.

The powertrain systems 10′ and 10″ according to the second and third examples are described below focusing on differences distinguishable from the powertrain system 10 according to the first example.

Referring to FIG. 3, the powertrain system 10′ according to the second example may include the motor 430 disposed between the engine 410 and the clutch 420.

Referring to FIG. 4, the powertrain system 10″ according to the third example may include the motor 430 connected to the engine 410 through a rotational shaft S2 different from a rotational shaft S1 connecting the engine 410 and the clutch 420.

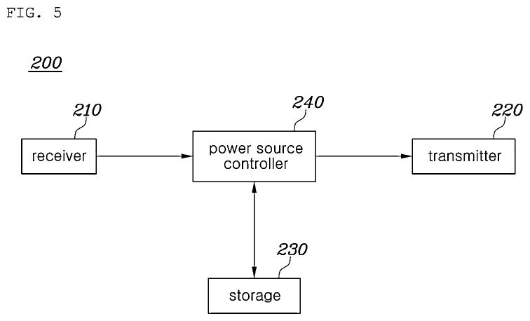

FIG. 5 is a diagram showing a configuration of an upper-level controller (or an apparatus for controlling a power source of a hybrid vehicle), according to an embodiment of the present disclosure.

Referring to FIGS. 1-5, the upper-level controller 200 may include, but not limited to, a receiver 210, a transmitter 220, a storage 230, and a power source controller 240.

The receiver 210 (sometimes referred to herein as a first communicator), according to an embodiment, may receive information, and may transmit the received information to the power source controller 240.

The receiver 210 may receive engine-related information, for example, engine-related information from the ECU 310.

The transmitter 220 (sometimes referred herein as a second communicator), according to an embodiment, may transmit information or data from the power source controller 240. For example, the transmitter 220 may transmit a control value from the power source controller 240 to the lower-level controller 300.

According to an embodiment, the transmitter 220 may receive the engine control torque and the motor control torque from the power source controller 240. The transmitter 229 may transmit the engine control torque to the ECU 410, and may transmit the motor control torque to the MCU 330.

The storage 230, according to an embodiment, may store an algorithm for performing the operations of the power source controller 240 and/or various pieces of information needed for the operations of the power source controller 240 in advance. The storage 230 may also store information or results acquired or generated according to the operations of the power source controller 240.

According to an embodiment, the storage 230 may previously store an algorithm for predicting the engine torque fluctuations and various LUTs. In embodiments, the various LUTs may include an inertial torque LUT, a motoring pressure torque LUT (an idle state motoring pressure torque LUT, and an open state motoring pressure torque LUT), a combustion pressure torque LUT, etc.

The storage 230 may include at least one type of storage medium, such as memories of a flash memory type, a hard disk type, a micro type, and a card type (e.g., a secure digital (SD) card) or an extreme digital (XD) card)), and memories of a random access memory (RAM), a static RAM (SRAM), a read only memory (ROM), a programmable ROM (PROM), an electrically erasable PROM (EEPROM), a magnetic RAM (MRAM), a magnetic disk, and/or an optical disk.

The power source controller 240, according to an embodiment, may be configured to perform general operations of the upper-level controller 200 (or an apparatus for controlling a power source of a hybrid vehicle). The power source controller 240 may include at least one processor.

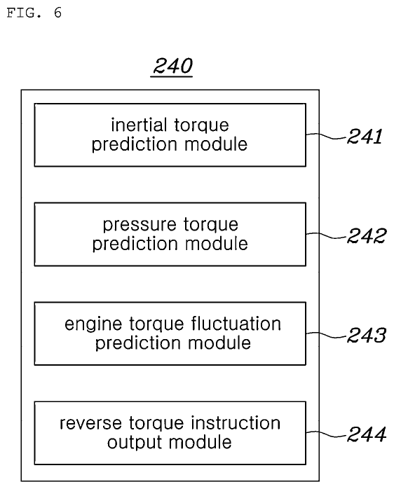

FIG. 6 is a diagram showing a configuration of the power source controller 240, according to an embodiment of the present disclosure.

Referring to FIGS. 1-6, the power source controller 240, according to an embodiment of the present disclosure, may include an inertial torque prediction module 241, a pressure torque prediction module 242, and an engine torque fluctuation prediction module 243.

The inertial torque prediction module 241, according to an embodiment, may predict the inertial torque (or an inertial torque component) based on the engine RPM included in the engine-related information.

For example, the inertial torque prediction module 241 may predict the inertial torque with reference to the inertial torque LUT tabulated by mapping the inertial torque according to the engine RPM.

The pressure torque prediction module 242, according to an embodiment, may predict the pressure torque (or a pressure torque component) based on the engine RPM and the required engine torque included in the engine-related information.

According to an embodiment, the pressure torque prediction module 242 may predict the motoring pressure torque and the combustion pressure torque based on the engine RPM and the required engine torque.

For example, the pressure torque prediction module 242 may predict the motoring pressure torque with reference to the motoring pressure torque LUT tabulated by mapping the motoring pressure torque according to the engine RPM and the required engine torque.

The motoring pressure torque included in the motoring pressure torque LUT may be the sum of i) the motoring pressure torque (i.e., the idle state motoring pressure torque) analyzed based on the engine RPM and the required engine torque when the throttle valve is closed and ii) the motoring pressure torque (i.e., the open state motoring pressure torque) analyzed based on the engine RPM and the required engine torque when the throttle valve is fully open.

In an embodiment, the pressure torque prediction module 242 may predict the motoring pressure torque with reference to i) an idle state motoring pressure torque LUT tabulated by mapping the motoring pressure torque according to the engine RPM and the required engine torque when the throttle valve is closed and ii) an open state motoring pressure torque LUT tabulated by mapping the motoring pressure torque according to the engine RPM and the required engine torque when the throttle valve is fully open.

The pressure torque prediction module 242 may extract the motoring pressure torque corresponding to the engine RPM and the required engine torque from the idle state motoring pressure torque LUT and the open state motoring pressure torque LUT. The pressure torque prediction module 242 may predict the motoring pressure torque based on the sum of the two extracted motoring pressure torques.

The pressure torque prediction module 242 may predict the combustion pressure torque with reference to the combustion pressure torque LUT tabulated by mapping the combustion pressure torque according to the required engine torque.

The engine torque fluctuation prediction module 243, according to an embodiment, may predict the engine torque fluctuations (or the engine roll vibration torque components) based on the inertial torque, the pressure torque (the motoring pressure torque and the combustion pressure torque), and the required engine torque.

According to an embodiment, the engine torque fluctuation prediction module 243 may predict the engine torque fluctuations by the process of adding the inertial torque and the pressure torque and subtracting the required engine torque from the sum of the inertial torque and the pressure torque.

The power source controller 240, according to an embodiment, may further include a reverse torque instruction output module 244.

The reverse torque instruction output module 244, according to an embodiment, may predict the reverse torque for the engine torque fluctuations to offset the engine torque fluctuations predicted by the engine torque fluctuation prediction module 243. The reverse torque instruction output module 244 may output the reverse torque instruction based on the predicted reverse torque to the MCU 330 of the lower-level controller 300.

the reverse torque may have an opposite phase to and the same magnitude as the engine torque fluctuations.

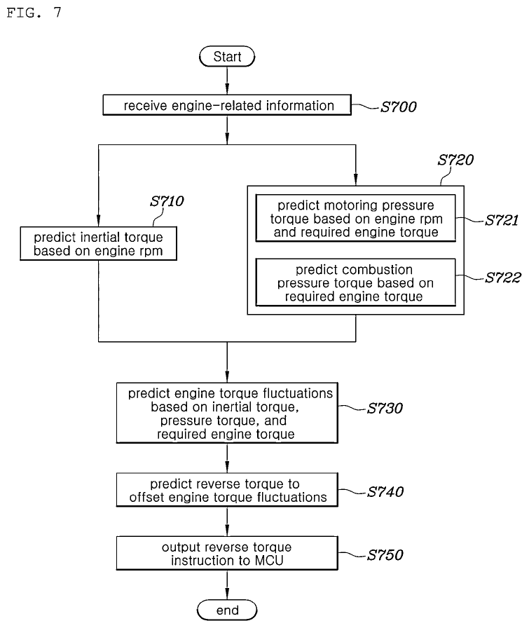

FIG. 7 is a diagram for describing operations of an upper-level controller (or an apparatus for controlling a power source of a hybrid vehicle) 200, according to an embodiment of the present disclosure.

The stepwise operations shown in FIG. 7 may be performed by the upper-level controller (or the apparatus for controlling the power source of the hybrid vehicle) 200 described above with reference to FIGS. 1-6.

In an operation S700, the upper-level controller 200 may receive the engine-related information. Here, the engine-related information may include the engine RPM and the required engine torque. For example, the upper-level controller 200 may receive the engine-related information from the ECU 310.

In an operation S710, the upper-level controller 200 may predict the inertial torque (or the inertial torque component) based on the engine RPM included in the engine-related information.

In the operation S710, the upper-level controller 200 may predict the inertial torque with reference to the inertial torque LUT tabulated by mapping the inertial torque according to the engine RPM.

In an operation S720, the upper-level controller 200 may predict the pressure torque (or the pressure torque component) based on the engine RPM and the required engine torque included in the engine-related information.

The operation S720 may include operations S721 and S722. In the operation S721, the upper-level controller 200 may predict the motoring pressure torque based on the engine RPM and the required engine torque. In the operation S722, the upper-level controller 200 may predict the combustion pressure torque based on the required engine torque.

In the operation S721, the upper-level controller 200 may predict the motoring pressure torque with reference to the motoring pressure torque LUT tabulated by mapping the motoring pressure torque according to the engine RPM and the required engine torque.

The motoring pressure torque included in the motoring pressure torque LUT may be the sum of i) the motoring pressure torque (an idle state motoring pressure torque) analyzed based on the engine RPM and the required engine torque when the throttle valve is closed and ii) the motoring pressure torque (an open state motoring pressure torque) analyzed based on the engine RPM and the required engine torque when the throttle valve is fully open.

In the operation S721, the upper-level controller 200 may predict the motoring pressure torque with reference to i) the idle state motoring pressure torque LUT tabulated by mapping the motoring pressure torque according to the engine RPM and the required engine torque when the throttle valve is closed and ii) the open state motoring pressure torque LUT tabulated by mapping the motoring pressure torque according to the engine RPM and the required engine torque when the throttle valve is fully open.

The upper-level controller 200 may extract the motoring pressure torque corresponding to the engine RPM and the required engine torque from each of the idle state motoring pressure torque LUT and the open state motoring pressure torque LUT. The upper-level controller 200 may predict the motoring pressure torque by adding the two extracted motoring pressure torques.

In an operation S730, the upper-level controller 200 may predict the engine torque fluctuations (or the engine roll vibration torque components) based on the inertial torque, the pressure torque (the motoring pressure torque and the combustion pressure torque), and the required engine torque (S730).

In the operation S730, the upper-level controller 200 may predict the engine torque fluctuations by the processes of adding the inertial torque and the pressure torque and subtracting the required engine torque from the sum of the inertial torque and the pressure torque.

In an operation S740, the upper-level controller 200 may predict the reverse torque for the engine torque fluctuations to offset the predicted engine torque fluctuations.

The predicted reverse torque in the operation S740 may have an opposite phase to and the same magnitude as the engine torque fluctuations.

In an operation S750, the upper-level controller 200 may output the reverse torque instruction corresponding to the reverse torque to the MCU 330 of the lower-level controller 300 as a control torque instruction for the motor (S750).

Although embodiments of the present disclosure have been described in detail with reference to the accompanying drawings, the disclosure is not necessarily limited to these embodiments. Rather, the present disclosure may be embodied in various ways without departing from the technical scope of the disclosure. Accordingly, the embodiments disclosed herein do not limit the present disclosure but are intended to illustrate the technical scope of the present disclosure. Therefore, the embodiments described above are for illustrative purposes only, and are not restrictive. The scope of the present disclosure should be construed by the appended claims and all technical ideas within the equivalent scope should be construed as being included in the scope of the present disclosure.

What is claimed is:

1. An apparatus for controlling a power source of a hybrid vehicle, the apparatus comprising:
a storage configured to store one or more algorithms for predicting engine torque fluctuations and store one or more look-up tables (LUT); and
a power source controller configured to
predict an inertial torque and a pressure torque related to an engine based on engine-related information,
predict engine torque fluctuations based on the engine-related information, the inertial torque, and the pressure torque, and
output a reverse torque instruction to offset the engine torque fluctuations.

2. The apparatus of claim 1, wherein the power source controller is configured to:
predict a reverse torque to offset the engine torque fluctuations; and
output the reverse torque instruction corresponding to the reverse torque.

3. The apparatus of claim 1, wherein the power source controller is configured to predict the engine torque fluctuations by subtracting a required engine torque from a sum of the inertial torque and the pressure torque.

4. The apparatus of claim 1, wherein the engine-related information includes engine revolutions per minute (RPM) and a required engine torque.

5. The apparatus of claim 4, wherein the power source controller is configured to predict the inertial torque corresponding to the engine RPM with reference to an inertial torque LUT tabulated with the inertial torque according to the engine RPM.

6. The apparatus of claim 4, wherein the power source controller is configured to:
predict, based on the engine RPM and the required engine torque, a motoring pressure torque with respect to the pressure torque; and
predict a combustion pressure torque based on the required engine torque.

7. The apparatus of claim 6, wherein the power source controller is configured to predict the motoring pressure torque with reference to a motoring pressure torque LUT tabulated with the motoring pressure torque according to the engine RPM and the required engine torque.

8. The apparatus of claim 6, wherein the power source controller is configured to:
extract a first motoring pressure torque from an idle state motoring pressure torque LUT;
extract a second motoring pressure torque from an open state motoring pressure torque LUT; and
predict the motoring pressure torque based on a sum of the first motoring pressure torque and the second motoring pressure torque.

9. A method of operating an apparatus for controlling a power source of a hybrid vehicle, the method comprising:
predicting an inertial torque based on engine-related information;
predicting a pressure torque based on the engine-related information;
predicting engine torque fluctuations based on the engine-related information, the inertial torque, and the pressure torque; and
outputting a reverse torque instruction to offset the engine torque fluctuations.

10. The method of claim 9, wherein predicting the engine torque fluctuations comprises predicting the engine torque fluctuations by subtracting a required engine torque from a sum of the inertial torque and the pressure torque.

11. The method of claim 9, wherein the engine-related information includes an engine revolutions per minute (RPM) and a required engine torque.

12. The method of claim 11, wherein predicting the inertial torque comprises predicting the inertial torque corresponding to the engine RPM with reference to an inertial torque LUT tabulated with the inertial torque according to the engine RPM.

13. The method of claim 11, wherein predicting the pressure torque comprises predicting a motoring pressure torque based on the engine RPM and the required engine torque and predicting a combustion pressure torque based on the required engine torque.

14. The method of claim 13, wherein predicting the pressure torque comprises predicting the motoring pressure torque with reference to a motoring pressure torque LUT tabulated with the motoring pressure torque according to the engine RPM and the required engine torque.

15. The method of claim 13, wherein predicting the pressure torque comprises:
extracting a first motoring pressure torque from an idle state motoring pressure torque LUT;
extracting a second motoring pressure torque from an open state motoring pressure torque LUT; and
predicting the motoring pressure torque based on a sum of the first motoring pressure torque and the second motoring pressure torque.

16. The method of claim 9, wherein outputting the reverse torque instruction comprises:
predicting a reverse torque to offset the engine torque fluctuations; and
outputting the reverse torque instruction corresponding to the reverse torque.

17. A system for controlling a power source of a hybrid vehicle, the system comprising:
a vehicle information provider configured to provide vehicle-related information;
an apparatus for controlling the power source of the hybrid vehicle; and
a motor control unit (MCU) configured to control a motor based on a reverse torque instruction output from the apparatus for controlling the power source of the hybrid vehicle,
wherein the apparatus for controlling the power source of the hybrid vehicle includes
a storage configured to store one or more algorithms for predicting engine torque fluctuations and store one or more look-up tables (LUT), and
a power source controller configured to
predict an inertial torque and a pressure torque related to an engine based on engine-related information,
predict engine torque fluctuations based on the engine-related information, the inertial torque, and the pressure torque, and
output a reverse torque instruction to offset the engine torque fluctuations.
